(19) United States
(12) Patent Application Publication
(10) Pub. No.: US 2024/0192717 A1
(43) Pub. Date: Jun. 13, 2024

(54) POWER SUPPLY

(71) Applicant: DH Technologies Development Pte. Ltd., Singapore (SG)

(72) Inventors: Martian D. DIMA, Richmond Hill (CA); Graham Arthur LEITH, Toronto (CA)

(73) Assignee: DH Technologies Development Pte. Ltd., Singapore (SG)

(21) Appl. No.: 18/556,200

(22) PCT Filed: Apr. 29, 2022
(86) PCT No.: PCT/IB2022/054010

§ 371 Date: Oct. 19, 2023

Related U.S. Application Data
(60) Provisional application No. 63/182,552, filed on Apr. 30, 2021.

(51) Int. Cl. G05F 3/16; H01J 49/02; H01J 49/40

(52) U.S. Cl. CPC G05F 3/16; H01J 49/022; H01J 49/40

(57) ABSTRACT

In some disclosed example embodiments, an apparatus, such as an ion detector or ion optics in a mass spectrometer, includes a power supply having two terminals and configured to provide a voltage of a first value between the two terminals, and a voltage regulator connected between the two terminals of the power supply. The voltage regulator includes a varistor, such as a metal-oxide varistor (MOV), and a current limiting circuit, such as a resistance device, connected in series with the varistor. The current limiting circuit is configured to bias the varistor to operate continuously in a breakdown mode. The apparatus can further include electrodes, such as those configured to influence flight of charged particles, with at least one of the electrodes connected to one end of the varistor, and at least another one of the electrodes connected to the other end of the varistor.

### CROSS-REFERENCE TO RELATED APPLICATION

This application is being filed on Apr. 29, 2022, as a PCT International Patent Application that claims priority to and the benefit of U.S. Provisional Application No. 63/182,552, filed on Apr. 30, 2021, which application is hereby incorporated herein by reference.

### BACKGROUND

Robust regulated power supplies are important in many applications. For example, in certain instruments, such as certain types of ion detectors or ion optics in mass spectrometers, high voltage discharges occur at various components, such as electrodes that influence flight of charged particles. Such discharges put considerable stress, in the form of current or voltage surges, on the power supplies. Power supply components need to be capable of withstanding such stress.

### SUMMARY

In some embodiments, a power supply includes a power supply portion having two terminals and configured to provide a voltage of a first value between the two terminals, and a voltage regulator connected between the two terminals of the power supply. The voltage regulator includes a varistor, such as a metal-oxide varistor (MOV), and a current limiting circuit, such as a resistance device, connected in series with the varistor. The current limiting circuit is configured to bias the varistor to operate continuously in a breakdown mode.

In some embodiments, an apparatus includes a power supply and a load. The power supply includes the power supply described above. The load includes electrodes, such as those configured to influence flight of charged particles. At least one of the electrodes is connected to one end of the varistor, and at least another one of the electrodes is connected to the other end of the varistor.

In some embodiments, an ion detector or ion optics for a mass spectrometer includes a power supply and electrodes configured to influence flight of charged particles. The power supply includes the power supply described above. At least one of the electrodes is connected to one end of the varistor, and at least another one of the electrodes is connected to the other end of the varistor.

In some embodiments, a method for supplying power to an electrical device, the method includes supplying a first voltage, such as a DC voltage, between two terminals; connecting a current limiting circuit, such as a resistive device, and an MOV device at a junction to form a serial combination; connecting the serial combination between the two terminals; connecting an electrode of the electrical device to the junction; and operating the MOV device in a continuous breakdown mode.

### BRIEF DESCRIPTION OF THE DRAWINGS

FIG. 1 shows a schematic circuit diagram of an electrical device according to some embodiments.

FIG. 2A depicts a current-voltage curve for a metal-oxide varistor (MOV), with a load line and indication of the operating point according to some embodiments.

FIG. 2B depicts a magnified portion, labeled “2B,” of FIG. 2A, with labels of certain terms used in this disclosure, according to some embodiments.

FIG. 3 shows a schematic circuit diagram of an electrical device according to some embodiments.

FIG. 4 outlines a method of providing power to an electrical device according to some embodiments.

### DETAILED DESCRIPTION

This disclosure relates to electrical power supplies and electrical devices that include such power supplies. Robust regulated power supplies are important in many applications. For example, in certain instruments, such as certain types of ion detectors and/or ion optics in mass spectrometers, high differential voltages (e.g., 100 to 200 volts) are applied to various electrodes to influence the flight (e.g., speed and/or direction) of charged particles (e.g., electrons and ions) in vacuum conditions (e.g., an air pressure of 10-8 to 1 kPa, in some cases lower). In such systems, high-voltage discharges can occur at various components, such as the electrodes of the detector. Such discharges put considerable stress, in the form of current or voltage surges, on the power supplies. In some traditional power supplies for such ion detectors, voltage regulation is provided by floating shunt regulators that include semiconductor devices, such as single-P-N-junction devices (e.g., Zener diodes), integrated circuits, and transistors. The overvoltage and/or overcurrent conditions caused by the discharges can easily damage such semiconductor devices, resulting in failure of the regulating function. In some cases, the regulated voltage is reduced to zero, made inaccurate, or made noisy by this failure. This, in turn, affects the trajectory of ions, resulting in loss of performance (e.g., sensitivity, resolution) or resulting in the appearance of spectral peak artefacts. Certain embodiments disclosed in this disclosure provide power supplies and components capable of withstanding such stresses.

In some embodiments, varistors, particular examples of which include metal oxide varistors (MOVs), are used as voltage regulators instead of traditional planar, or monocrystalline, semiconductor voltage regulators. MOV's are normally only used as circuit protective devices and not as voltage regulating elements. However, for certain applications, it has been discovered that MOVs are suitable voltage regulators. For example, for certain low-current (<<1 mA) applications, MOVs can be used without long-term degradation, with at least an acceptable level of performance (e.g., accuracy) and increased robustness as compared to planar semiconductor regulators.

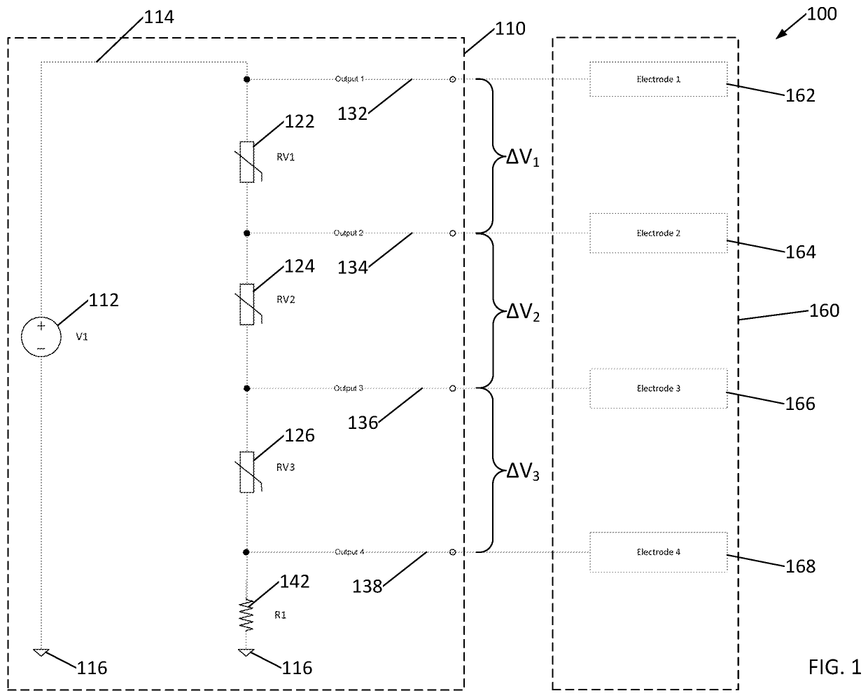

In an example embodiment, as shown by the circuit diagram in FIG. 1, an electrical device 100, such as an ion detector or ion optics (e.g., a focusing lens assembly), includes a power supply portion 110 and a load module 160. The power supply 110 includes a power supply 112, which in some embodiments outputs a DC voltage between a high-voltage terminal 114 and a low-voltage terminal 116, which in this example is ground but can be at another fixed electrical potential or floating. The DC voltage can be any voltage suitable for the specific application the power supply 112 is designed. For example, for certain ion detectors the output voltage, V1, of the power supply 112 can be nominally 2000 to 4000 volts. The power supply 112 in some embodiments is a regulated power supply, such as a single-output high voltage DC-DC converter, or an unregulated power supply.

The power supply module 110 in this example further includes one or more (in this case, three) MOVs 122, 124, 126 as regulators and a resistor 142 as a currently limiting circuit. The first, second, and third MOVs RV1 122, RV2 124, RV3126 and resistor R1 142 are connected in series between the first terminal 114 and second terminal 116 of the power supply 112, and provide four outputs: first output 132 at the first terminal 114; second output 134 at the junction between MOVs 122, 124; third output 136 at the junction between MOVs 124, 126; and fourth output 138 between MOV 126 and resistor 142.

The load module 160 in the example shown in FIG. 1 includes four electrodes, each connected to a respective output of the power supply module 110: First electrode 162 connected to the first output 132; second electrode 164 connected to the second output 134; third electrode 166 connected to the third output 136; and fourth electrode 168 connected to the fourth output 138. Thus, the differential voltage (electrical potential difference) ΔV₁ between the first and second electrodes 162, 164 is the voltage across the first MOV 122; the differential voltage ΔV₂ between the second and third electrodes 164, 166 is the voltage across the second MOV 124; and the differential voltage ΔV₃ between the third and fourth electrodes 166, 168 is the voltage across the third MOV 126.

It is noted that in this example, differential voltages ΔV₁, ΔV₂, and ΔV₃ in this example are regulated without planar semiconductor devices, including any single-P-N-junction device, such as any Zener diode.

The current limiting circuit, in this case resistor R1 142, has a resistance value, which can be chosen to set the current through the MOVs 122, 124, 126 at a level that prevents degradation of the MOVs 122, 124, 126, as discussed in more detail below.

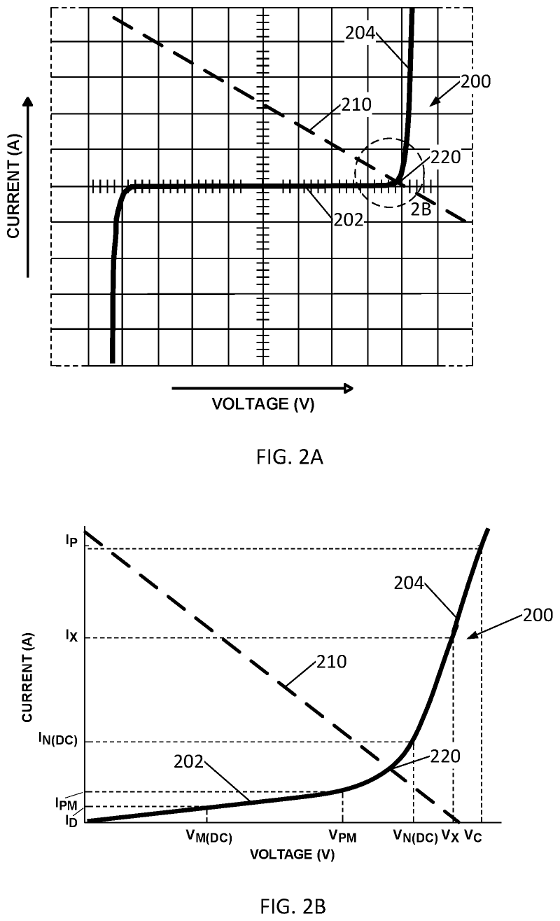

The operation conditions of the MOVs 122, 124, 126 are set, in some embodiments, as discussed below in conjunction with FIGS. 2A and 2B, where FIG. 2B shows a portion (labelled “2B”) of FIG. 2A in more detail. FIG. 2A shows a typical current-voltage (I-V) curve 200 (i.e., a plot of current, I_{X}, vs. voltage, V_{X}) for an MOV, where the voltage is measured across the MOV and current through the MOV. The curve 200 is substantially symmetrical with respect to the origin, i.e., the point at which both the voltage and current are zero. Referring to the positive voltage half of the curve 200, as the voltage is increased from zero, the current increases slowly in a first portion 202, sometimes referred to as the “leakage region,” of the I-V curve 200. The resistance of the MOV in the leakage region is thus very high. As the voltage is further increased beyond a sharp transition, the current increases rapidly within a narrow voltage range in a second portion 204, sometimes referred to as the “breakdown region,” of the I-V curve 200. Thus, voltage regulation can be achieved by driving an MOV into the breakdown region. For example, in the graph in FIG. 2A, if each major division in the voltage direction is 50 V, voltage for breakdown region 204 is about 200 V, and the MOV can be used to regulate a differential voltage of about 200 V. As illustrated in FIG. 2A, the I-V curve 200 of an MOV and the load line 210 of the circuit to which the MOV is connected intersect at the operating point 220 of the MOV.

As depicted in FIG. 2B, the I-V curve 200 of an MOV can be characterized by certain specific current-voltage pairs. For example, in the leakage region 202, a “rated DC voltage, V_{M(DC)}, which is the maximum continuous DC voltage which may be applied for an MOV, can be specified by a manufacturer of the MOV; and a corresponding “DC standby current,” I_{D}, which is the varistor current measured at rated DC voltage, can be specified. A “rated recurrent peak voltage,” which is the maximum recurrent peak voltage which may be applied for a specified duty cycle and waveform, can be specified; and a corresponding current, I_{PM}, can be specified. A “nominal varistor voltage,” V_{N(DC)}, which is the voltage across the varistor measured at a specified pulsed DC current, I_{N(DC)}, of a specific duration, can be specified; and the I_{N(DC)} can be specified. A “clamping voltage,” V_{C}, which is the peak voltage across the varistor measured under conditions of a specified peak V_{C} pulse current, I_{P}, and specified waveform; and I_{P} can be specified.

In some embodiments, the current-limiting circuit 142 can be chosen to set the load line 210 such that the operating point 220 of each MOV 122, 124, 126 is in the breakdown region 204, with a voltage regulated at a level that is acceptable for the particular application, and at a sufficiently low current so as to not cause significant degradation of the MOV 122, 124, 126. In some embodiments, for example, the resistance value of the resistor 142 is selected to set the current through the varistors 122, 124, 126 to be at about I_{N(DC)}, corresponding to the nominal varistor voltage V_{N(DC)}. In other embodiments, the current can be set to lower than I_{N(DC)}, for example at 50%, 25%, 10% I_{N(DC)} or lower. For example, in some embodiments, wherein I_{N(DC)} is 1.0 mA, the varistors can be set to operate at a current of 60 to 100 μA. The lower the operating current, the lower the power dissipation by an MOV. Operating MOVs at low current levels (e.g., at 10% I_{N(DC)} or lower) is advantageous in certain applications, such as those applying high voltages to electrodes in vacuum, as current surges, such as those caused by electrode discharges are less likely to result in power dissipation at levels beyond what the MOVs are designed to tolerate. In some embodiments, an MOV can have a rated continuous power dissipation level, for example the product of I_{N(DC)} and V_{N(DC)}. Operating an MOV at 10% I_{N(DC)}, for example, would result in a power dissipation at 10% of the rated power dissipation level.

In some embodiments, such as the example in FIG. 1, where the power supply 112 is a DC power supply, the MOVs 122, 124, 126 are biased to operate continuously in DC mode, or the breakdown region 204. In some embodiments, MOVs, such as the MOVs 122, 124, 126 in FIG. 1, are disposed in vacuum, e.g., in an environment with air pressure of 1 kPa or lower, such as 1 Pa or lower, or 10⁻⁷ to 10⁻³ Pa or lower. In some embodiments, the MOVs are disposed in the same vacuum chamber (or another type of space of controlled atmosphere). The low operating currents discussed above help ensure that the energy dissipated in the MOVs (i.e., heat) does not accumulate to a degree that would cause damage to the MOVs.

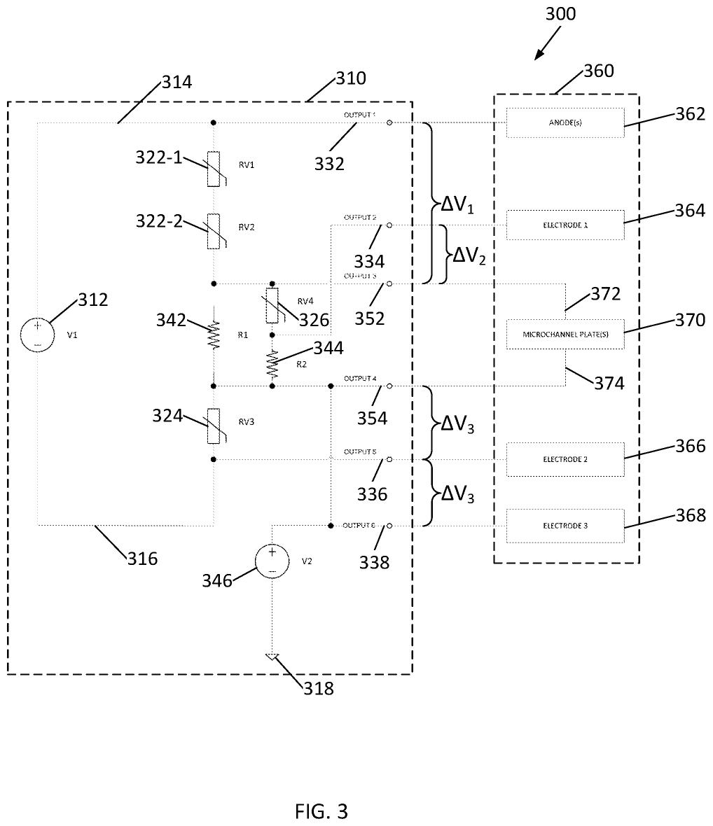

In another embodiment, as shown in the circuit diagram in FIG. 3, an ion detector 300 includes a power supply portion 310 and detector module 360, which is powered by the power supply module 310 and performs the detection functions. The power supply module 310 includes a power supply 112, which outputs a high DC voltage between a positive terminal 314 and a negative terminal 316, which in this example is floating. The DC voltage can be any voltage suitable for the specific application the power supply 312 is designed. For example, for certain ion detectors the output voltage, V1, of the power supply 312 can be nominally 2500 volts. The power supply 312 in some embodiments is a regulated power supply, such as a floating high voltage DC-DC converter.

The power supply portion 310 in this example further includes MOVs 322-1, 322-2, 324, 326 as regulators and resistors 342, 344 as a currently limiting circuits. The first and second MOVs RV1 322-1, RV2 322-2, resistor R1 342, and the third MOV RV3 are connected in series between the first terminal 314 and second terminal 316 of the power supply 312. The fourth MOV RV4 326 and second resistor R2 344 are connected in series across the first resistor R1 342. The power supply module 310 in this example provides six outputs: first output 332 at the first terminal 314; second output 334 at the junction between the fourth MOV 326 and second resistor 344; third output 352 at the junction between the second MOV 322-2 and first resistor 342; fourth output 354 between the first resistor 342 and third MOV 324; fifth output 336 at the second terminal 316; and six output 338 connected to the fourth output 354. The power supply module 310 further includes a second power supply 346, which outputs a voltage V2 between the sixth output 338 and a third terminal 318, which in this example is ground. The second power supply 346 in this example is a high voltage DC-DC converter but can be any device that is capable of providing the requisite voltage. In some embodiments, V2 is positive relative to ground; in other embodiments V2 is negative relative to ground.

The detector module 360 in the example shown in FIG. 3 includes six electrodes, each connected to a respective output of the power supply module 310: One or more anode electrode 362 connected to the first output 332; first electrode 364 connected to the second output 334; second electrode 366 connected to the fifth output 336; third electrode 368 connected to the sixth output 338; fourth electrode 372 connected to the third output 352; and fifth electrode 374 connected to the fourth output 354. The detector module 360 in this example further includes a set of one or more microchannel plates 370 connected between the fourth and fifth electrodes 372, 374. Thus, the one or more anode electrodes are biased at the potential of the first terminal 314, or at V1+V2−ΔV₃ above ground; the fourth electrode 372 is biased at a potential about two nominal varistor voltages (ΔV₁) below that of the first terminal 314; the first electrode 364 is biased at about one nominal varistor voltage (ΔV₂) below the fourth electrode 372; the fifth electrode 374 and third electrode 368 are biased at V2 above ground; and the second electrode 366 and the second terminal 316 are biased at about one nominal varistor voltage (ΔV₃) below V2.

It is noted that in this example, similar to the example depicted in FIG. 1, differential voltages ΔV₁, ΔV₂, and ΔV₃ in this example are regulated without planar semiconductor devices, including any single-P-N-junction device, such as any Zener diode.

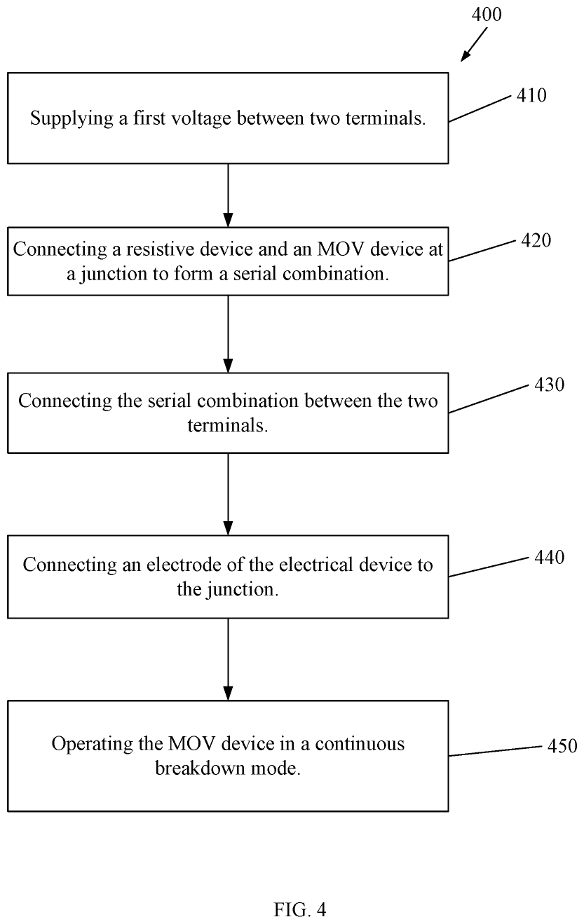

As outlined in FIG. 4, in some embodiments, a method 400 of supplying power to an electrical device includes: supplying 410 a first voltage between two terminals; connecting 420 a resistive device and an MOV device at a junction to form a serial combination; connecting 430 the serial combination between the two terminals; connecting 440 an electrode of the electrical device to the junction; and operating 450 the MOV device in a continuous breakdown mode.

Using MOVs as regulating elements in the shunt regulator networks, as in the examples disclosed above, makes the power supplies and instruments that include such power supplies much more robust against high voltage discharges. MOVs are designed as circuit-protective devices and to absorb much greater overstress energy without damage than semiconductor-based devices such as Zener diodes, integrated circuits, and transistors. The inventors have found that on certain research instruments, such as time-of-flight (TOF) mass analyzers with MOV-based regulators use for the power supply modules, significant reduction in failures of the regulator circuits have been achieved relative to instruments using Zener diodes and/or transistor regulators. In addition, the MOV regulator circuits are more compact than regulators based on Zener diodes, transistors, or integrated circuits. For example, MOV-based regulator circuits eliminate the need for series resistors and parallel capacitors in the Zener regulator network. Attempts to make traditional regulator circuits as robust as the MOV regulator circuits result in the need for even larger components and additional protective components. In one example, the compactness of the MOV regulator circuit allowed the consolidation of two circuit boards into a single circuit board, resulting in significant cost savings.

This disclosure describes some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. An apparatus, comprising:
a power supply having two terminals and configured to provide a voltage of a first value between the two terminals; and
a voltage regulator connected between the two terminals of the power supply and comprising:
a first varistor having a first and second terminals; and
a current limiting circuit connected in series with the varistor;
the current limiting circuit being configured to bias the varistor to operate continuously in a breakdown mode.

2. The apparatus of claim 1, further comprising one or more second varistors forming a serial combination with the first varistor and current limiting circuit, the current limiting circuit being configured to bias both the first and the one or more second varistors to operate continuously in a breakdown mode.

3. The apparatus of claim 1, wherein the current limiting circuit comprises a resistive device.

4. The apparatus of claim 1, wherein the first varistor has a nominal varistor voltage and is configured to operate at a specified DC test current level when the varistor is biased at the nominal varistor voltage, and the current limiting circuit is configured to bias the varistor to operate at a current level no higher than the specified DC test current level.

5. The apparatus of claim 4, wherein the current limiting circuit is configured to bias the varistor to operate at a current level no higher than about 50% of the specified DC test current level.

6. The apparatus of claim 5, wherein the current limiting circuit is configured to bias the varistor to operate at a current level no higher than about 10% of the specified DC test current level.

7. The apparatus of claim 1, wherein the varistor comprises a metal oxide varistor (MOV).

8. The apparatus of claim 1, wherein the voltage regulator is free of any planar semiconductor device.

9. The apparatus of claim 1, wherein the first varistor has a rated power dissipation under a set of predetermined conditions, and the voltage regulator is configured to operate with an energy dissipation by the first varistor of no higher than about 10% of the rated energy dissipation when operating under the set of predetermined conditions.

10. (canceled)

11. The apparatus of claim 1, further comprising an electrical device having a plurality of electrodes and configured to be energized by electrical power received at the electrodes, a first one of the plurality of electrodes being connected to the first terminal of the first varistor, and the second one of the plurality of electrodes being connected to the second terminal of the first varistor.

12. The apparatus of claim 2, further comprising an electrical device having a plurality of electrodes and configured to be energized by electrical power received at the electrodes, wherein:
the first varistor and the one or more second varistors are connected to each other in a serial combination having a first end and a second end;
a first of the plurality of electrodes of the electrical device is connected to the first end of the serial combination of the first varistor and the one or more second varistors; and
the second of the plurality of electrodes being connected to the second end of the serial combination of the first varistor and the one or more second varistors.

13. A device for a mass spectrometer, the device comprising:
a plurality of electrodes, each of which is configured to, when energized, influence flight of charged particles; and
a power source configured to energize the plurality of electrodes, the power source comprising:
a power supply having two terminals and configured to provide a voltage of a first value between the two terminals; and
a voltage regulator connected between the two terminals of the power supply and comprising:
a first MOV device having a first and second terminals; and
a current limiting circuit connected in series with the varistor device;
the current limiting circuit being configured to bias the MOV device to operate continuously in a breakdown mode;
one of the plurality of electrodes being connected to the first terminal of the first MOV device, and another one of the plurality of electrodes being connected to the second terminal of the first MOV device.

14-15. (canceled)

16. The device of claim 13, wherein the current limiting circuit comprises one or more microchannel plates and one or more resistance devices, each of which connected to a respective one of the one or more microchannel plates in parallel.

17. The device of claim 13, wherein the current limiting circuit comprises one or more microchannel plates and one or more capacitors, each of which connected to a respective one of the one or more microchannel plates in parallel.

18. The device of claim 13, wherein the first MOV device comprises one or more MOVs, each of which having a nominal varistor voltage and is configured to operate at a specified DC test current level when the MOV is biased at the nominal varistor voltage, and the current limiting circuit is configured to bias the one or more MOVs to operate at a current level no higher than the specified DC test current level for each of the one or more MOVs.

19. The device of claim 13, wherein the first MOV device comprises two or more MOVs connected in a serial combination connected between the first and second terminals.

20. The device of claim 13, wherein at least a subset of the plurality of electrodes are configured to operate in an environment of a pressure of about 1 Pa or lower.

21-22. (canceled)

23. A method of supplying electrical power to an electrical device, the method comprising:
supplying a first voltage between two terminals;
connecting a resistive device and an MOV device at a junction to form a serial combination;
connecting the serial combination between the two terminals;
connecting an electrode of the electrical device to the junction; and
operating the MOV device in a continuous breakdown mode.

24. The method of claim 23, wherein the first MOV device comprises one or more MOVs, each of which having a nominal varistor voltage and is configured to operate at a specified DC test current level when the MOV is biased at the nominal varistor voltage, wherein the operating the MOV device in a continuous breakdown mode comprises:
connecting the one or more MOVs in series with the resistive device; and
biasing the one or more MOVs to operate at a current level no higher than about the specified DC test current level for each of the one or more MOVs.

25. The method of claim 22, wherein the operating the MOV comprises operating the MOV device in a continuous breakdown mode in an environment of a pressure of 1 kPa or lower.
